(19) United States
(12) Patent Application Publication
(10) Pub. No.: US 2007/0272661 A1
(43) Pub. Date: Nov. 29, 2007

(54) Diamond Bonding

(76) Inventors: Andrew John Whitehead, Camberley (GB); Bartholomeus Mathias Van Oerle, Nijmegen (NL); Christopher John Howard Wort, Wantage Oxfordshire (GB); Thomas Josef Schaich, Meerbusch (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 10/586,360

(22) PCT Filed: Jan. 12, 2005
(86) PCT No.: PCT/IB05/00045

§ 371 Date: May 9, 2007

Related U.S. Application Data
(60) Provisional application No. 60/538,457, filed on Jan. 26, 2004.

(30) Foreign Application Priority Data
Jan. 16, 2004 (GB) 0400978.3

(51) Int. Cl. B23K 15/00; B23K 1/005; C04B 37/02

(52) U.S. Cl. 219/121.14

(57) ABSTRACT

A method of producing a bonded structure which includes a layer of material capable of forming a diffusion or diffusion-type bond with diamond bonded to a diamond element. The method includes the step of applying electron beam heating to a localised region of contacting surfaces between the diamond and the layer of material, or the layer of material and a surface of a metal element or structure to cause bonding of at least some of the contacting surfaces in that region. The method has particular application to the bonding of a layer of diamond to a frame or mount.

### BACKGROUND OF THE INVENTION

This invention relates to diamond bonding and, more particularly, to diamond bonding using electron beam heating.

A variety of methods are known for bonding of components, each with its own advantages. Such methods include:

welding, where a component typically metallic, and filler if used, are melted;

brazing, where a melted filler chemically reacts with a component surface;

diffusion bonding, where the components are assembled, generally with a thin layer of a diffusible material placed between them, and then heated under pressure typically to about 0.4 of the absolute melting point of the diffusion bonding layer;

soldering, where the melted filler wets but does not chemically react with the surface of the component;

gluing, where a polymeric hardening or reactive process is used.

The bonding processes set out above are listed in a general order of decreasing bond temperature and decreasing bond strength. For any particular application the requirement is to select a process which provides sufficient bond and yet does not degrade the bonded materials significantly due to the bond temperature or other bond characteristics.

Diamond is a difficult material to bond to other materials in a manner that is both strong and reliable. This difficulty is largely due to the very low chemical reactivity of diamond. Further difficulty arises because of its very low thermal expansion compared with most other materials, which combined with its high elastic modulus can result in very high thermally induced stresses after a bonding process at raised temperature.

The requirement for bonding diamond elements, such as windows, to frames, typically metal or ceramic, for inclusion into larger assemblies is well established. In many applications this mounting is required to provide mechanical integrity, good thermal contact and a gas tight seal for vacuum, pressure, or fluid containment applications. Generally, it is advantageous to minimise the thermal stresses induced by mounting so as to maximise the design strength available for environmental factors. EP 0 761 623A1 describes the use of an active (reactive) braze technique, wherein brazing takes place by heating the entire assembly above the melting point of the high melting temperature (>450° C.) reactive filler. PCT/IB 00/00172 describes a method of forming a joint between a CVD (chemical vapour deposition) diamond and a metal support structure, where the diamond is first bonded to a ceramic body having thermal expansion characteristics compatible with those of CVD diamond, which in turn is bonded to a dimensionally compliant, intermediate metal element. The metal element is then secured to the metal supporting structure. These intermediate components are designed to reduce the thermal stresses inevitably arising from forming the bond by elevating the temperature of the entire structure and then cooling the bonded structure. However, in both these cases a limitation is that the final structure is either complex or under significant thermal stress, or both.

### SUMMARY OF THE INVENTION

According to the present invention, a method of producing a bonded structure which includes a layer of material capable of forming a diffusion or diffusion-type bond with diamond bonded to a diamond element includes the step of applying electron beam heating to a localised region of contacting surfaces between the diamond and the layer of material, or the layer of material and a surface of a metal element or structure to cause bonding of at least some of the contacting surfaces in that region.

The material of the layer, as mentioned, will be capable of forming a diffusion or diffusion-type bond with the diamond. The material will typically be a carbide forming metal or alloy containing a carbide forming metal. Examples of suitable carbide forming metals are titanium and molybdenum.

Thus, in one form of the invention, a layer of the diffusible material is bonded in a localised region to a surface of a diamond element using electron beam heating.

In another form of the invention, a surface of the diamond is provided with a layer of the diffusible material. In this form of the invention, the coated surface is brought into contact with the surface of a metal element or structure and electron beam heating is applied to create a localised bonding region with the contacting surfaces. This electron beam heating can also be used to create a bond between the layer in contact with the diamond surface, if such bond was not created during coating of that surface. The metal of the element or structure may, for example, be a ferrous metal, a non-ferrous metal or an alloy containing either such metal. Examples of suitable metals and alloys of this nature are copper, aluminium or steel.

The invention has particular application to the bonding of a layer of diamond to a frame or mount. In this form of the invention, the frame or mount will typically be made of the material capable of forming a diffusion or diffusion-like bond with the diamond. The electron beam heating may be applied to the frame or mount such as to create a localised bond between a surface of the frame or mount and the diamond layer. Alternatively, a thin layer of the material capable of forming a diffusion or diffusion-like bond with the diamond may first be applied to the diamond surface. In this form of the invention, the electron beam heating will create localised bonding between the thin layer and the diamond, where this has not already been formed by the method of applying the layer to the diamond surface, and also between the mount and the thin layer.

The electron beam heating must take place under conditions in which degradation of the diamond is minimised or avoided. Typically the electron beam heating takes place in a vacuum.

The method of the invention has several advantages over known methods of bonding layers to diamond:
1. The process is a clean process in that it is carried out typically in a vacuum chamber, and does not ordinarily generate particulates. It also does not generally require the use of oxygen or other oxidant or surface chemical etchants.
2. The heat input is very rapid and highly localised. The general temperature of the assembly thus remains at ambient temperatures, so that there is no subsequent cooling of the assembly as a whole, and so large thermal stresses are avoided. This also minimises the total energy input and damage to the diamond.
3. The bond can be narrow, or can be deliberately broadened or comprise of multiple bond lines. The exact form of the bond can thus be chosen according to the application.
4. No filler material is required.
5. The heat affected region is small.
6. The likelihood of thermal effects, such as diamond element distortion, is reduced.
7. The process is well suited to precision bonding.

Typical conditions for producing suitable electron beam heating are currents in the range 0.01 A-10 A and voltages in the range 1 kV-100 kV.

It is preferred that the conditions of electron beam heating are such that there is a substantial absence of any melting of the material of the layer, in particular away from the local area being immediately heated by the electron beam and at the diamond surface.

The temperature of the surface of the structural element bonding to the diamond preferably does not exceed its melting point, and more preferably does not exceed 80% of its melting point, and even more preferably does not exceed 65% of its melting point and most preferably does not exceed 50% of its melting point.

The electron beam may be used simultaneously or sequentially to cause melting at some other region of the structural component, for example to form an electron beam weld between the other components of the structure. Thus the focal point of the electron beam may not be at the bond between the structure and the diamond element.

Where used, the intermediate layer of material capable of forming a diffusion or diffusion-like bond with the diamond may be applied to a surface of the diamond by a variety of known techniques. Amongst these are evaporation, where the diffusion bond between this layer and the diamond will not generally be formed at this stage, and sputtering, where the diffusion bond between this layer and the diamond may generally be at least partly formed.

The method of the invention is applicable to a variety of diamond elements. The diamond of these elements may be that produced by chemical vapour deposition (CVD diamond) and may be polycrystalline or single crystal in nature. The diamond may also be natural single crystal diamond or single crystal diamond synthesised by high temperature/high pressure techniques.

### BRIEF DESCRIPTION OF THE DRAWINGS

The invention will now be described in more detail, by way of example only, with reference to the accompanying drawings in which:

FIG. 1 illustrates a sectional side view of a first embodiment of the invention, and

FIG. 2 illustrates a sectional side view of a second embodiment of the invention.

### DESCRIPTION OF EMBODIMENTS

In the described embodiments, a diamond layer or window is bonded to a supporting cylinder.

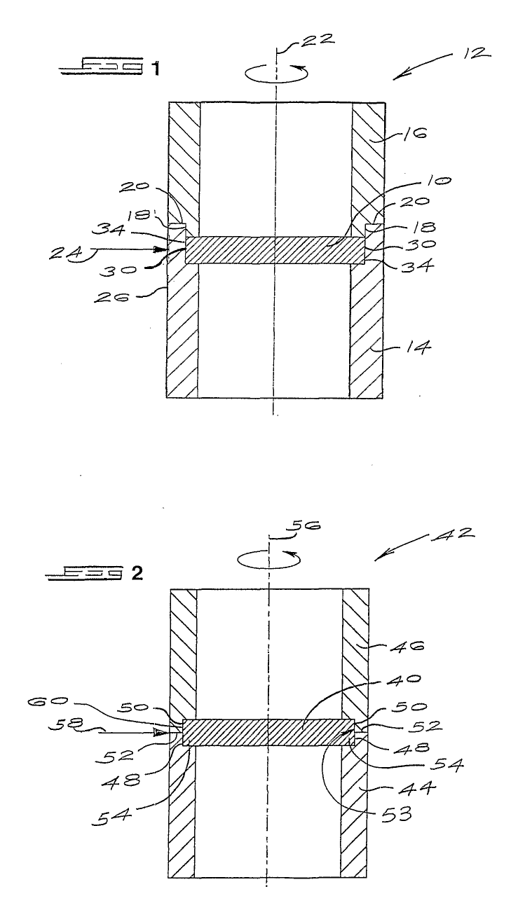

Referring first to FIG. 1, a diamond window or layer 10 is mounted in a cylinder 12. The cylinder 12 consists of two interlocking sections 14, 16. The lower section 14 has a recess 18 in which the diamond layer 10 is located. The section 16 has a matching end profile 20 creating an overlapping join.

In order to create a bond between the section 14 and the diamond layer 10, the assembly is placed in a chamber of an electron beam welding machine and rotated about the axis 22. The electron beam is applied in the direction of arrow 24, which is perpendicular to the axis of rotation 22. The beam is directed at the outside surface 26 of the section 14, although the focus of the beam is generally near the interface with the diamond if the largest temperature excursion is required at this point. The heating effect of the electron beam results in bonding between the diamond layer 10 and the section 14 in the narrow and localised region indicated by 30.

In a specific example of the invention, a polycrystalline CVD diamond layer or window 10 was prepared with lapped flat faces and laser cut edges. The CVD diamond layer 10 was mounted in a titanium cylinder 12 as indicated in FIG. 1. An electron beam was directed at the assembly, as described above, resulting in the formation of a thin layer of titanium carbide at the interface between the diamond layer 10 and the section 14 in the region 30. It was only necessary to supply sufficient heat to the assembly for the titanium in contact with the diamond to react with the diamond. The titanium of the tube was locally melted at the external surface, but not melted at the surface in contact with the diamond. The entire bonding process took a few tens of seconds.

On removal of the bonded assembly from the vacuum chamber, the join was shown to be leak tight to better than 10⁻⁸ Pa·l/s with negligible distortion. An added advantage of the method described above is that the localised heating and absence of fusion meant there was no overrun of the window by bond material that required subsequent cleaning.

In another specific example of the invention, a diamond window in a titanium cylinder was produced, except that prior to placing the diamond layer 10 in the assembly, a thin layer of titanium was sputter coated on the peripheral surface 34 of the diamond layer 10.

A second embodiment of the invention is illustrated by FIG. 2. Referring to this figure, a diamond layer or window 40 is mounted in a cylinder 42. The cylinder 42 comprises upper and lower sections 44, 46. The sections 44, 46 have end sections 48, 50 which are recessed. The sections, when joined, create a butt joint at 52. The butt jointed sections define a recess 53, which accommodates a peripheral edge 54 of the diamond layer 40.

In order to bond the sections 44, 46 to the diamond, the cylinder is rotated about the axis 56. Electron beam heating is directed at the butt joint 52 in direction of arrow 58 perpendicular to the axis of rotation. The electron beam conditions are chosen to achieve melting of the outer surface of the tube thus forming a butt weld joint between the sections 44 and 46 and a temperature at the edge surface 60 of the diamond window such as to create a diffusion bond between the diamond and the sections 44, 46. The surface 60 may be titanium coated in which case it is the titanium coat which will form a diffusion bond with the diamond.

In the embodiments described above, the electron beam conditions may be chosen such as to obtain melting of the cylinder sections to a point where such melting takes place at the diamond edge surface.

In general the above embodiments describe an electron beam which is normal to the interface at which bonding is to take place, with the point of focus of the electron beam being either at the interface or at some controlled distance from it. The electron beam is then scanned, or the object moved under the electron beam, or a combination of these actions utilised, so that the point at which it intersects the bonding interface moves in the manner required to form the bonding path intended.

Alternatively, the electron beam can lie close to or in the plane of the bonding surface, and bond over a significant length of the electron beam where it passes through or adjacent to the bonding interface. The electron beam may then move along the bonding interface in a direction normal to the direction of the beam, so as to form an extended bond. Alternatively, or in addition, the point of focus of the electron beam may be moved along the length of the beam to control the bonding along the length of the beam.

Where electron beam heating is being used for two separate functions, for example creating the diffusion bond with the diamond element or the bond between the layer on the diamond and the mount (or both of these) and in addition is used to form the joint between two elements of the mount, then these two functions may be completed in a single electron beam processing step, or in two immediately sequential steps, or in two separate sequential steps, depending on the application.

1. A method of producing a bonded assembly comprising a diamond element, the method including the steps of providing a diamond element and at least one other structural element for the assembly, contacting at least one surface on the diamond element with at least one surface on the structural element, and applying electron beam heating to a localised region of the contacting surfaces to cause bonding of at least a portion of the contacting surfaces in that region.

2. A method according to claim 1, wherein the structural element is formed of a material that is capable of forming a diffusion or diffusion-type bond with the diamond element.

3. A method according to claim 2, wherein the structural element is formed of a carbide forming material.

4. A method according to claim 3, wherein the structural element is formed of titanium or molybdenum.

5. A method according to claim 1, wherein a surface of the diamond element is coated or otherwise provided with a layer of a material that is capable of forming a diffusion or diffusion-type bond with the diamond element, the coated surface of the diamond element being brought into contact with the structural element prior to the localised application of electron beam heating to cause bonding of at least a portion of the contacting surfaces.

6. A method according to claim 5, wherein the structural element is formed of a ferrous metal, a non-ferrous metal, or an alloy of either such metal.

7. A method according to claim 6, wherein the structural element is formed of copper, aluminium or steel.

8. A method according to any one of claims 5 to 7, wherein the coating layer is formed of a carbide forming material.

9. A method according to claim 8, wherein the coating layer is formed of titanium or molybdenum.

10. A method according to any one of the preceding claims, wherein the electron beam heating is carried out under conditions in which the temperature of the surface of the structural element bonding to the diamond does not exceed its melting point.

11. A method according to claim 10, wherein the temperature of the surface of the structural element bonding to the diamond does not exceed 80% of its melting point.

12. A method of producing a bonded assembly comprising a diamond element, the method including the steps of providing a diamond element and at least one other structural element for the assembly, which structural element is formed of material that is capable of forming a diffusion or diffusion-type bond with diamond, contacting at least one surface on the diamond element with at least one surface on the structural element and applying electron beam heating to a localised region of the contacting surfaces to cause bonding of at least a portion of the contacting surfaces in that region.

13. A method of producing a bonded assembly comprising a diamond element, the method including the steps of providing a diamond element and at least one other structural element for the assembly, coating at least one surface of the diamond element with a material that is capable of forming a diffusion or diffusion-type bond with diamond, contacting the at least one coated surface of the diamond element with at least one surface of the structural element, and applying electron beam heating to a localised region of the contacting surfaces to cause bonding of at least a portion of the contacting surfaces in that region.

14. A method according to claim 12 or claim 13, wherein the electron beam heating is carried out under conditions in which the temperature of the surface of the structural element bonding to the diamond does not exceed its melting point.

15. A method according to claim 14, wherein the temperature of the surface of the structural element bonding to the diamond does not exceed 80% of its melting point.

16. A method according to any one of the preceding claims, wherein the diamond element is a layer of diamond.

17. A method according to any one of the preceding claims, wherein the structural element is a frame or mount.

18. A method according to any one of the preceding claims, wherein the electron beam heating takes place in a vacuum.

19. A method according to any one of the preceding claims, wherein the electron beam heating takes place at currents in the range of 0.01 A-10 A and voltages in the range of 1 kV-100 kV.
